(19) United States
(12) Patent Application Publication
(10) Pub. No.: US 2026/0203987 A1
(43) Pub. Date: Jul. 16, 2026

(54) DYNAMIC GENERATION OF CUSTOMIZED ANIMATIONS

(71) Applicant: Google LLC, Mountain View, CA (US)

(72) Inventors: Vikhyat Janaki Ram Reddy Devireddy, Sunnyvale, CA (US); Haifeng Gong, Fremont, CA (US); Xiaohang Li, Cupertino, CA (US); Jiachen Wang, San Jose, CA (US); Weiguang Yang, Sunnyvale, CA (US); Xiao Feng, Santa Clara, CA (US)

(21) Appl. No.: 19/023,040

(22) Filed: Jan. 15, 2025

(51) Int. Cl. G06T 13/80; G06N 20/10

(52) U.S. Cl. CPC G06T 13/80; G06N 20/10

(57) ABSTRACT

Methods, systems, and apparatus, including computer programs encoded on a computer storage medium, for automated generation of animations. The system obtains digital content data comprising one or more digital components, obtains an animation template that defines a structure for the animation, processes input data comprising at least the digital content data to determine one or more style features of the animation, and generates animation data defining the animation by applying the determined style features to the one or more digital components and the animation template.

### BACKGROUND

This specification relates to data processing, artificial intelligence, and generating and customizing digital components using artificial intelligence.

In a computer networked environment such as the Internet, third-party content providers provide third-party content items for display on end-user computing devices. These third-party content items, for example, digital images and video, can be displayed on client devices in the environment. Digital images and video can be used, for example, on the Internet, for remote meetings via video conferencing, high-definition video entertainment, and/or sharing of user-generated content.

### SUMMARY

This specification describes methods, computer systems, and apparatus, including computer programs encoded on computer storage media, for generating and customizing animations based on a collection of information and/or other content related to subjects of the animations.

In this specification, an animation refers to a digital component that provides a dynamic visual representation by simulating movement through a sequence of frames. Unlike still images, which remain static and unchanging, animations depict the motions or transformations of one or more elements, such as images, text, icons, or graphics, creating a visual representation of element movements or changes.

In one aspect, this specification describes a method for generating and customizing animations. The method can be implemented by a system including one or more computers. The system obtains digital content data comprising one or more digital components. The system obtains an animation template that defines a structure for the animation, the template comprising (i) one or more component slots, each component slot configured to hold at least one of the digital components, and (ii) animation parameters that define animation properties for at least one of the digital components. The system processes input data comprising at least the digital content data to determine one or more style features of the animation. The system generates animation data defining the animation by applying the determined style features to the one or more digital components and the animation template. The system further distributes the animation to one or more client devices.

In some implementations, the digital components comprise one or more of: an image, text data, a logo, or a graphic shape.

In some implementations, the style features comprise one or more of: a scale, a position, a font, a font size, an aspect ratio, a display color, a rotation, an opacity, an animation timing of one or more components of the animation.

In some implementations, to process the input data to determine the one or more style features of the animation, the system processes a first input comprising data characterizing at least one of the digital components using a first machine learning model to generate an output comprising at least one of the one or more style features. In some cases, the first input further comprises contextual data characterizing one or more of: a device type of the client devices, user interface settings, viewing mode, a user profile, digital content presented prior to or concurrently with the animation, or a time of day.

In some implementations, to obtain the animation template, the system processes an input characterizing one or more of: attributes of the one or more digital components, or contextual information, to select the animation template from a set of animation templates.

In some cases, the system receives a query that comprises characteristics of one or more videos in a video feed, and the contextual information comprises the characteristics of the one or more videos in the video feed.

In some cases, to process the input to select the animation template, the system processes the input using a second machine learning model to generate an output that identifies the animation template.

In some implementations, to obtain the digital content data comprising one or more digital components, the system receives a query that comprises characteristics of one or more videos in a video feed; and selects the one or more digital components based on the characteristics of one or more videos in a video feed.

In some implementations, to distribute the animation to one or more client devices, the system generates a rendered animation file; and distributes the rendered animation file to the client devices.

In some implementations, to distribute the animation to one or more client devices, the system distributes a file that defines animation instructions to the client devices and rendering the animation at the client devices using an animation engine.

This specification also provides a system including one or more computers and one or more storage devices storing instructions that, when executed by the one or more computers, cause the one or more computers to perform the method described above.

This specification also provides one or more computer storage media storing instructions that when executed by one or more computers, cause the one or more computers to perform the method described above.

Particular embodiments of the subject matter described in this specification can be implemented so as to realize one or more of the following advantages. This specification describes techniques for enabling a computer system to automatically generate and customize animations from digital components, such as images and/or text, or other content using animation templates, which may be predefined. The system customizes each generated animation with appropriate style features, such as color schemes, font choices, and/or motion trajectories, enhancing its ability to effectively deliver information and capture audience attention and/or engagement.

In a video feed environment where most content items are videos, converting static content items into dynamic content items can improve the user experience and engagement. For instance, animations provide a more seamless and cohesive user experience in a video feed environment by maintaining consistency with the dynamic nature of video content, reducing the visual disruption caused by static elements. Furthermore, animations can be more effective at capturing users'attention and conveying messages compared to static content items. For example, animated components can highlight key aspects of the content, such as emphasizing a logo or a call-to-action, through motion and transitions, thereby enhancing the clarity and impact of the message.

There are a number of technical challenges faced when trying to automate the generation and customization of animations. For example, it can be difficult to determine the optimal set of style features for a given animation, given the wide range of possible options and the complex interplay between different visual elements.

Furthermore, the system needs to select style features that not only fit the subject but also create a visually cohesive and pleasing overall design. Failure to choose suitable or optimized styles may lead to low-quality and underperforming candidate animations, resulting in wasteful consumption of computational resources through testing and/or distributing numerous inadequate options. For example, the testing for each candidate animation can include generating the animation, transmitting the animation to many users, collecting data related to user interactions with the animation, and generating and analyzing performance metrics based on the collected data. The generation and testing of many animations result in substantial amounts of wasted computing resources in generating the candidate digital components and collecting the data, and wasted network bandwidth in transmitting the candidate digital components to the users and collecting the data. Such inadequate options can also waste resources of client devices, such as battery power, CPU cycles, memory, etc., to display content that is ignored by the users of the client devices.

The processes discussed herein include operations to overcome the above technical challenges, for example, by using machine learning models to determine the optimal, or at least a preferred or target set of style features for a given animation. The disclosed techniques result in improved quality of automatically generated animations and saving of computing resources that would have been wasted for generating and evaluating sub-optimal digital components. In particular, certain embodiments described herein include employing machine learning models to analyze the digital components and contextual information to select appropriate style features, thereby resulting in a higher quality animation than those resulting from processes that do not include such stages.

The techniques described herein provide particular uses of AI to solve problems associated with generating and customizing animations that effectively deliver information and capture audience attention, by automating the selection of style features based on the content and context of the animation. The described techniques leverage AI technology, specifically, in some implementations, large language models, to process prompts describing the subject matter and to generate an output that guides the selection of style features. By automating the style selection process based on contextual understanding, rather than relying on manual or rule-based approaches, the described techniques represent an advancement in addressing the technical challenge of creating high-quality, engaging digital components that resonate with their intended audience.

Additionally, in some implementations, the described system renders the generated animations at the server side before distributing them to client devices. This server-side rendering approach ensures consistent playback quality across different client devices, minimizes the computational demands on client devices, and reduces compatibility issues associated with local rendering. Furthermore, by encoding animations in efficient formats, such as WebP or MP4, the system optimizes network bandwidth usage while maintaining high-quality visual output.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example environment in which generative artificial intelligence can be implemented.

FIG. 2 illustrates an example animation generation system.

FIG. 3 is a flow chart of an example process of generating an animation.

FIG. 4 is a block diagram of an example computer.

Like reference numbers and designations in the various drawings indicate like elements.

### DETAILED DESCRIPTION

This specification describes techniques for generating animations by combining and customizing digital components, such as images, text, and logos, and customizing visual characteristics of such content in the animations. In some cases, the described system uses artificial intelligence (AI) to generate and customize the animations. The AI system customizes the generated animations with one or more style features tailored to the animation's components and subject matter, enhancing its ability to effectively deliver information and capture audience attention and/or engagement.

AI is a segment of computer science that focuses on the creation of models that can perform tasks act autonomously, e.g., with little to no human intervention. AI systems can utilize, for example, one or more of machine learning, natural language processing, or computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

As used throughout this document, the phrase “digital component” refers to a discrete unit of digital content or digital information (e.g., image, text, a video clip, audio clip, animation, multimedia clip, gaming content, bullet point, artificial intelligence output, language model output, or another unit of content or unit of combined content). A digital component can electronically be stored in a physical memory device as a single file or in a collection of files, and digital components can take the form of video files, audio files, multimedia files, image files, or text files and include advertising information, such that an advertisement is a type of digital component.

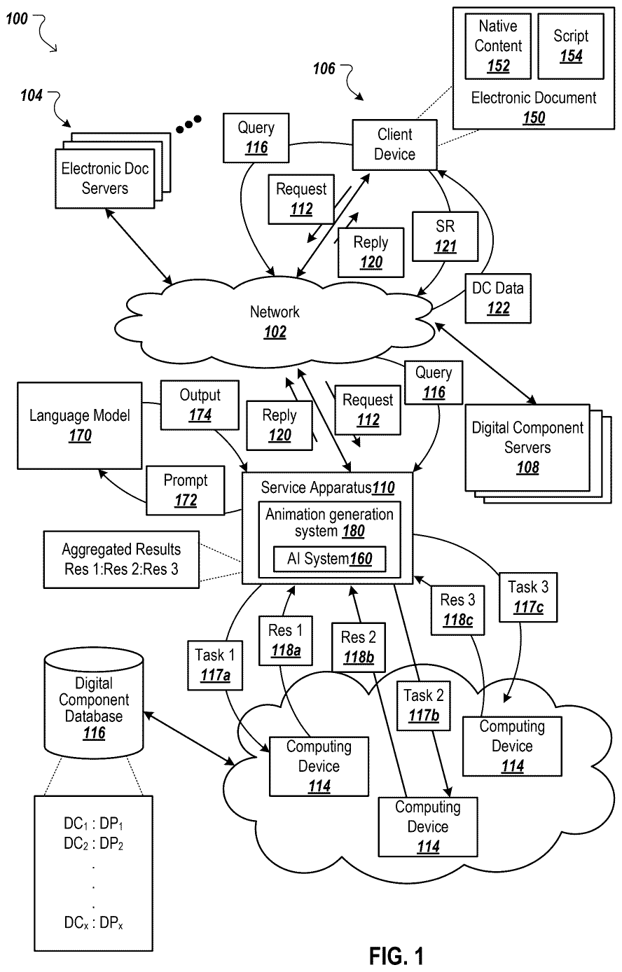

FIG. 1 illustrates an example of environment 100 in which a service apparatus 110 is configured to generate and distribute digital components, including animations. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, tablet devices, digital assistant devices, augmented reality devices, virtual reality devices, wearable devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords/topics/categories that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 includes an animation generation system 180 configured to autonomously generate digital components, either prior to a request 112 (e.g., offline) and/or in response to a request 112 (e.g., online or real-time). In some cases, the animation generation system 180 includes an AI system 160 that collects online content about a specific entity (e.g., digital component provider or another entity) and summarizes the collected online content using one or more language models 170, which can include large language models. Note that the language model 170 is depicted as being separate from the service apparatus 110, the animation generation system 180, and the AI system 160, but the language model 170 can be integrated into the service apparatus 110, the animation generation system 180, and/or the AI system 160.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution (e.g., a probability distribution) that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

The animation generation system 180 and/or the AI system 160 is configured to combine digital components, e.g., including an image with other content, such as text, other images, graphics, emojis, interactive elements, etc., to create a new animation based on an animation template.

For example, the new animation can be stored in the digital component database 116 with reference to distribution parameters and/or other information about the animation. The distribution parameters for the new animation can include the category of the new animation (e.g., a topic category). When the service apparatus 110 receives a request 112 for content specifying the category, the digital component database 116 can be searched to identify the match between the category in the request and the category to which the new animation is indexed. Based on the match, the service apparatus 110 can select the animation for distribution, and transmit the animation to a client device in response to the request 112.

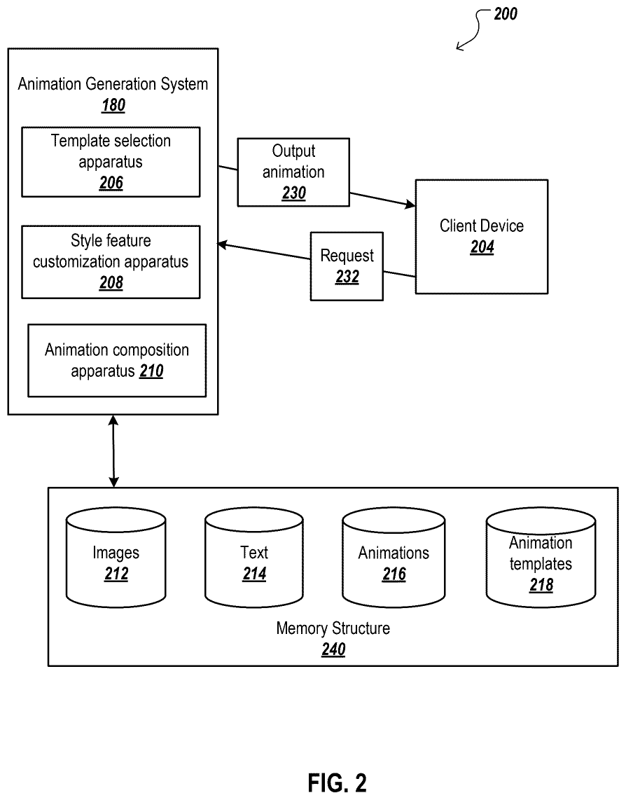

The description above refers to the new animation being created prior to receipt of the request 112. However, as described below with reference to FIG. 2, in some implementations, the new animation can be created after the service apparatus 110 receives the request for content in the category. In this way, the creation of the new animation can be dynamic in nature, and can therefore, leverage other information in the request that may not be known prior to receipt of the request (e.g., a time of day of the request). For example, the request can identify videos in a video feed and provide characteristics of those videos (e.g., topic, colors, etc.). This information can be used to select or generate an animation that seamlessly integrates with the surrounding video content. The animation can be further customized based on the characteristics of the current video, the next scheduled video, or other videos in the feed, enhancing the user experience and ad relevance. This dynamic creation of the new animation can also reduce the storage requirements of pre-generating the new animations.

In some implementations, the AI system 160 can generate a prompt 172 that is submitted to the language model 170, and causes the language model 170 to generate the output sequences 174, also referred to as “output”. In some cases, the AI system 160 can generate the prompt in a manner (e.g., having a structure) that identifies a list of online sources of information, such as a list of websites or data repositories, and specifying a set of constraints the language model 160 must use to generate a summary of information found at the online sources specified in the prompt 172. To initiate creation of the output sequences 174, the AI system 160 submits the prompt 172 to the language model 170, which uses the prompt 172 to evaluate the information found at the online sources specified in the prompt 172, and generate the output 174 that summarizes the information according to the constraints specified in the prompt 172.

In some implementations, the collected information can be used to classify entities into a hierarchical semantic structure. For example, based on the information collected for one entity, or a subset of available resources, the output 174 can be a categorization/sub-categorization of the information collected. In a specific example, assume that a set of resources (e.g., online web pages or files) is related to a bakery specializing in birthday cakes. In this example, the information collected can be used to assign the set of resources (e.g., for a particular entity) to the category of “bakery” and sub-category “birthday cakes” that is a sub-category of “bakery.” In this way, the category to which a given set of resources is semantically related can be determined, assigned to the set of resources and/or entity, and used as, at least part of, a summary of the set of resources and/or the entity. Note that the phrase category, as used herein, can be used to refer to both categories and sub-categories, and the term sub-category is used to differentiate a subordinate from a more general category to which the sub-category belongs.

In some cases, the AI system 160 can obtain a description prompt describing a subject of the new animation. In one example, the AI system 160 can insert the generated summary into an additional prompt that is submitted to the language model 170 (or another language model) as a constraint for generating the description prompt. The description prompt can be used as an input to the language model 170 (or another language model) to condition the language model to output a set of descriptions of features of the animation. As will be described below, the AI system 160 can use the output of the language model to select one or more style features for the animation.

FIG. 2 is a block diagram 200 illustrating interactions between the animation generation system 180, a client device 204, and a memory structure 240. In some situations, the animation generation system 180 and client device 204 can, respectively, be the same or similar to the animation generation system 180 and client device 106 of FIG. 1.

The animation generation system 180 includes a template selection apparatus 206, a style feature customization apparatus 208, and an animation composition apparatus 210. The following description refers to these different apparatuses as being implemented independently and each configured to perform a set of operations, but any of these apparatuses could be combined to perform the operations discussed below. Furthermore, the transmissions of data between various components can occur over any communications bus or network.

The animation generation system 180 is in communication with a memory structure 240. The memory structure 240, can include one or more databases or other appropriate structures/software for storing data. As shown, the memory structure 240 includes an image database of 212 storing images, a text database of 214 storing text items, an animation database of 216 storing animations, and an animation template database of 218 storing animation templates. Each of these databases can be implemented in the same hardware memory device, separate hardware memory devices, and/or implemented in a distributed cloud computing environment. In some cases, the memory structure 240 can store additional digital components, such as audio clips, logos, geometric shapes, interactive elements, and/or data for creating the interactive elements. The interactive elements can include, for example, buttons, checkboxes, and interactive icons that can be included in animations. Furthermore, for a given digital component, the memory structure 240 can store not only the digital component itself (e.g., a complete image or text block) but also its individual components (e.g., isolated image segments, individual text items), metadata (e.g., colors, sizes, or styles), web pages linked to by the digital component, and other related data.

Digital components such as images, text, logos, geometric shapes, and interactive elements stored in the memory structure 240 can be used as base components for composing animations by the animation generation system 180. For instance, the animation generation system 180 can retrieve a set of digital components from the memory structure 240, and the animation composition apparatus 210 can dynamically integrate these components into an animation according to an animation template.

The animation template database of 218 stores a set of pre-defined animation templates. Each animation template defines a framework for structuring and animating digital components in an animation. The animation template includes a set of component slots, each configured to receive a digital component, such as an image, text, or logo. The animation template also includes animation parameters that define how the digital components are animated, such as their movement, timing, and visual effects.

In an example of an animation template, the template defines an animation in which an image component moves in a first direction, and then a text component fades in and moves in a second direction. In another example, the template defines a central image slot that scales up from 50% to 100% size over 2 seconds, while text in a lower slot fades in concurrently. The background color transitions smoothly from a first color to a second color, and additional geometric shapes animate along predefined paths to add dynamic visual interest.

The style features of an animation generated based on the animation template can be adjusted by adjusting the animation parameters. For example, the background color, text size, component motion trajectory, and animation timing can be customized based on the animation's components and other information to enhance visual coherence, or improve viewer engagement.

Once a new animation is generated, it can be stored in the animation database 216. In some implementations, the new animation can be stored in association with distribution parameters (e.g., a subject category or other keywords) and/or a size of the animation. This can facilitate efficient selection of an appropriate animation to transmit to the client device 204 in response to a request 232 for content received from the client device 204.

For example, when the request for content 232 is received, aspect ratio data, dimensions, or other indications of the space available for presentation of an animation can be identified. More specifically, in some situations, the request for content may specify that the space in an electronic document that is available for presentation of an animation is an A×B pixel space. In these situations, the animation generation system 180 can determine whether the new animation fits in the available space based on the aspect ratio, dimensions, or other indications of space available (e.g., based on a comparison of the space available and the stored size information for the new animation). In response to determining that the new animation will fit in the available space, the animation generation system 180 can select the new animation for presentation, and transmit the new animation 230 to the client device 204.

The creation of the new animation can be performed prior to the receipt of the request 232 for content from the client device 204, or after the request for content 232 has been received. For example, a set of new animations can be created and stored for later distribution independent of any request for content from a client device.

In some cases, the new animation 230 can be created in response to the receipt of the request for content 232 from the client device 204. For example, when the request for content 232 is received, the subject category and/or dimensions specified therein can be identified and used to select a set of base components, including, e.g., (i) one or more images from the images database 212 and (ii) one or more phrases from the text database 214. Additional information, such as a time of day, device type of the client device 204, or other information can be used for selecting base components.

In some implementations, the animation generation system 180 can receive a query that characterizes videos in a video feed. This query can provide information about the current video being displayed, the next video scheduled to play, or characteristics of multiple videos in the feed. The animation generation system 180 can use this information to select the set of digital components as the base components for the new animation. For instance, if the query indicates that the videos in the feed are related to travel, the system 180 can select images and text related to travel destinations or experiences. This context-aware selection of digital components can enhance the relevance of the animation and improve user engagement.

Once the base components have been selected, they can be combined to create the new animation 226 according to an animation template, which can be styled according to the style features selected by the style feature customization apparatus 208. The animation generation system 180 can then transmit the new animation 226 to the client device 204 for presentations. In these implementations, the new animation can also be stored in the animation database 216, and used again later for distribution to other client devices 204, thereby reducing the need to recreate the new animation in response to a subsequent request for content.

The animation generation system 180 can obtain an animation template for generating the new animation 230 from a variety of sources. In some cases, the animation generation system 180 can receive a selection of the animation template from a user input or from another system. In some cases, the animation generation system 180 retrieves a default animation template from the animation template database 218. In some cases, the animation generation system 180 generates the animation template based on a signal specifying preferences for animation style, structure, or content arrangement. For example, an input from a user or another system can specify that the animation should prioritize text visibility or emphasize movement of image components.

In some cases, the template selection apparatus 206 automatically selects the animation template from the set of animation templates stored in the animation template database 218 based on an input signal. For example, the template selection apparatus 206 can process an input characterizing a context of the animation to be generated. The context can include features such as: characteristics of the digital components selected as the base components for the animation, characteristics of user interface for displaying the animation on the client device, a length of the animation, characteristics of the user of the client device 204, and/or the subject matter or other characteristics of digital content (e.g., a video) that is presented prior to or concurrently with the presentation of the new animation to be generated.

In some implementations, the animation generation system 180 can receive a query that characterizes videos in a video feed. This query can provide information about the current video being displayed, the next video scheduled to play, or the characteristics of multiple videos in the feed. The template selection apparatus 206 can use this information to select an animation template that integrates the new animation with the surrounding video content. For example, if the query indicates that the next video in the feed features a predominantly blue color scheme, the system 180 can select an animation template that uses complementary colors or avoids clashing with the blue tones.

The template selection apparatus 206 is implemented using at least one computing device (e.g., one or more processors). In some cases, the template selection apparatus 206 includes a machine learning model configured to process the input characterizing the context of the animation to generate an output that identifies the animation template. The machine learning model can be any appropriate type of machine learning models, such as a decision tree, a support vector machine (SVM), a neural network, etc., or combinations thereof. The machine learning model has been trained by the template selection apparatus 206 or another system based on training data generated from data sources such as example animations and templates, user interaction data, context-specific parameters (e.g., screen dimensions, user profiles), and performance metrics (e.g., engagement rates, click-through rates).

For instance, the training data can include labeled examples that associate specific animation templates with certain content categories or display contexts. This allows the machine learning model to learn patterns and correlations that inform the selection of an optimal template for a given context. After processing the input, the machine learning model generates an output, such as a ranked list of templates selected from the template database 218, a single best-fit template, or specific template parameters for selecting an existing template. This enables the animation generation system 180 to dynamically select or create templates that maximize the visual appeal and effectiveness of the generated animations.

The style feature customization apparatus 208 is implemented using at least one computing device (e.g., one or more processors), and can include one or more machine learning models. The style feature customization apparatus 208 is configured to determine the style features for the components of the animation template. As described above, the animation template includes animation parameters that define how the digital components are animated, such as their movement, timing, and visual effects. The style features of an animation generated based on the animation template can be adjusted by adjusting the animation parameters. The style features can include one or more of: a scale, a position, a font, a font size, an aspect ratio, a display color, a rotation, an opacity, an animation timing of one or more components of the animation.

In some cases, the style feature customization apparatus 208 can determine the animation parameters based on the digital components (such as images and text) selected as the base components of the new animation. For example, the background color, text size, component motion trajectory, and animation timing can be customized based on the animation's components as well as other relevant signals to enhance visual coherence, or improve viewer engagement.

For instance, the background color of the new animation can be dynamically set to a dominant or complementary color determined from the selected image to create a coherent visual theme. In another example, text size and placement can be adjusted to accommodate longer headlines or ensure readability across different screen sizes. Motion trajectories can be customized based on the relative sizes, aspect ratios, and positioning of components to ensure smooth transitions and avoid overlapping elements. Component timing can also be fine-tuned, e.g., based on the length and complexity of the text to ensure that viewers have enough time to read and comprehend the message, or based on the pacing of the animation to match the expected viewing duration or to align with accompanying audio or video content.

In some cases, the style feature customization apparatus 208 can take into account contextual signals, such as the device type, user preferences, or factors like light or dark mode settings on the client device 204, to further customize the animation's style features. For example, in dark mode, the background color and text contrast can be optimized to reduce eye strain, while in light mode, brighter colors may be emphasized to capture attention. By dynamically adjusting animation parameters, the style feature customization apparatus 208 ensures that the final animation adapts to the specific context in which it will be presented, maximizing its effectiveness and visual impact.

In some implementations, the style feature customization apparatus 208 can process the selected digital components to extract their characteristics, such as the dominant color of the images, the length and sentiment of the text, or the presence of faces or logos. In some cases, the style feature customization apparatus 208 can determine the style features of the new animation by using a rule-based process. For example, the style feature customization apparatus 208 can determine the one or more of the style features by querying the style feature database (e.g., stored in the memory structure 240). In these cases, the style feature database stores a set of data entries with each respective structured data entry linking (i) a respective set of characteristics extracted from the digital component features and/or contextual features with (ii) a respective set of style features for the new animation. The data entries in the style feature database can be obtained in any of a variety of means. In some cases, the data entries can be generated based on expert inputs. In other cases, the data entries can be generated by a machine learning model that has been trained to output optimal style feature selections for a combination of input signals.

In an illustrative example, the style feature customization apparatus 208 can analyze the selected components to extract their characteristics, including the image's dominant color and the text component's length and sentiment. If the input image has a dominant color of blue, the text component is within a threshold length and contains a positive sentiment, the style feature database can include an entry recommending a set of style features that include a light blue background color, and a large and bold font for the text.

In some implementations, the style feature customization apparatus 208 includes a machine learning model configured to process the input characterizing the digital components and/or the context of the animation to generate an output that identifies one or more of the style features. The machine learning model can be any appropriate type of machine learning models, such as a decision tree, a support vector machine (SVM), a neural network, etc., or combinations thereof. The machine learning model has been trained by style feature customization apparatus 208 or another system based on training data generated from data sources such as example animation features, animation components, user interaction data, context-specific parameters, and performance metrics (e.g., engagement rates, click-through rates). For instance, the training data can include labeled examples that associate specific animation style features with certain component characteristics, content categories, or display contexts.

In some cases, the machine learning model can include a language model configured to process an input that includes a textual description of the digital components, contextual parameters, ad/or desired animation characteristics to output a set of style features for the animation. For example, the textual description might specify that the animation should “emphasize image colors and ensure text readability” or “create a dynamic feel with smooth transitions and fast pacing.” The language model can interpret these descriptions and generate corresponding style features, such as background and text colors, font sizes, motion trajectories, and animation timing, that align with the specified goals.

Additionally, the language model can process inputs such as user-provided descriptions of a subject matter, audience preferences, or high-level creative goals. For instance, if the description specifies “minimalistic design with soft tones,” the language model can output recommendations for muted background colors, simple motion paths, and minimal visual effects, ensuring that the animation adheres to the desired design language. This allows the style feature customization apparatus 208 to adapt animations dynamically based on user-provided or system-generated textual inputs.

The language model can be pre-trained on a large corpus of text data to learn general language patterns and relationships. The language model can be further fine-tuned using supervised learning, e.g., based on labeled data of animation descriptions and corresponding style features. In some cases, the language model can be conditioned, e.g., through explicit constraints specified in prompts and/or through contextual learning, to output a specific set of style features or a range of suitable style features. The contextual learning can be performed by prompting the language model with a set of examples with each example including a respective input description and a respective output set of style features.

After the style features have been determined, the animation composition apparatus 210 can apply these features to the animation template to generate the animation 230. For instance, the animation composition apparatus 210 can map the selected digital components to the component slots and populate the animation parameters with the determined style features.

In some cases, the animation composition apparatus 210 can generate the animation as a file that defines the animation instructions, e.g., as a JSON file, a Lottie® file, or an HTML5 animation file, and distribute the animation file to the client device 204, so that the client device 204 can render the display of the animation at the client device using a corresponding animation engine. The advantages of this approach include reduced server-side computation and greater flexibility for the client device to render animations dynamically based on local conditions, such as device performance or user preferences. This method also enables lightweight file transmission and minimizes bandwidth usage during delivery.

In some other cases, the animation composition apparatus 210 can render the animation at the server side (i.e., at the animation generation system 180). In these cases, the animation composition apparatus 210 can render the animation instructions to generate the animation 230 in any of a variety of formats including, for example, a GIF, a WebM, an MP4, or a WebP. The advantages of server-side rendering include ensuring consistent playback quality across client devices, regardless of their processing capabilities, and eliminating the need for a client-side animation engine. This approach is particularly beneficial for client devices with limited computational resources or when delivering animations to platforms that do not support dynamic rendering.

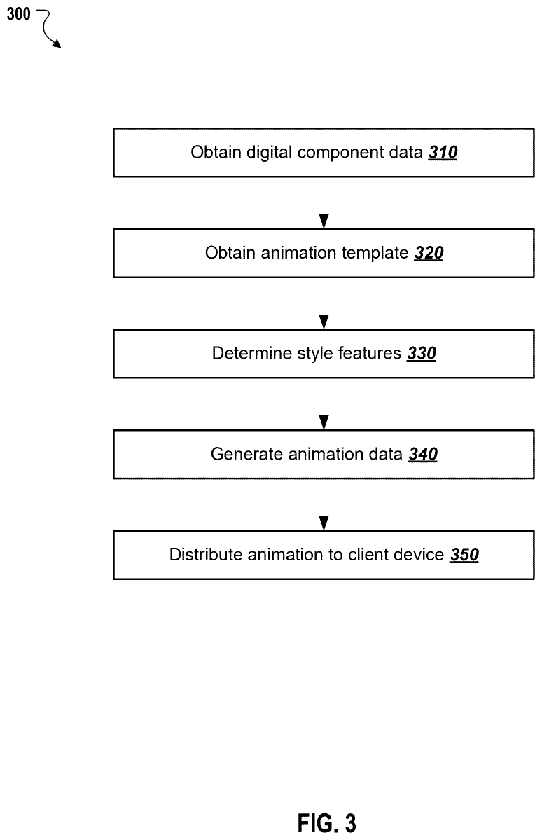

FIG. 3 is a flow diagram of an example process 300 for generating an animation. Operations of the process 300 can be performed by a system of one or more computers located in one or more locations, e.g., the animation generation system 180 described with references to FIG. 1 and FIG. 2, appropriately programmed in accordance with this specification. Operations of the process 300 can also be implemented as instructions stored on one or more computer-readable media, which may be non-transitory, and execution of the instructions by one or more data processing apparatus can cause the one or more data processing apparatus to perform the operations of the process 300. For convenience and without loss of generality, the process 300 will be described as being performed by a data processing apparatus, e.g., a computer system.

At 310, the system obtains digital content data. The digital content data includes a set of digital components that can include, e.g., one or more images, text data, logos, graphic shapes, or interactive elements. As described above, the system can select the digital components from one or more databases stored in a memory structure.

At 320, the system obtains an animation template. As described above, in some cases, the system can retrieve the animation template from an animation template database, which stores a set of predefined templates. Each animation template defines a structure for the animation, including component slots for holding digital components and animation parameters that define properties such as movement, timing, and visual effects. In some cases, the system can process an input characterizing digital content attributes or contextual information to select the animation template from the database. As described above, the selection can be performed using a machine learning model.

At 330, the system determines a set of style features for the animation. As described above, the system processes input data, including the digital components and optionally contextual data, to determine the style features. The style features can include one or more of: a scale, a position, a font, a font size, an aspect ratio, a display color, a rotation, an opacity, or an animation timing. The determination of the style features can involve processing the input data using a machine learning model trained on historical animation data or applying rules stored in a style feature database.

At 340, the system generates animation data. As described above, the system applies the determined style features to the animation template and maps the digital components to the corresponding component slots. The animation parameters in the template are populated with the style features to define the behavior of the components during the animation. The system can generate the animation data in a format such as a JSON file, a Lottie® file, or a rendered animation file in formats like GIF, WebP, or MP4.

At 350, the system distributes the generated animation to a client device. As described above, the distribution can involve sending a file defining the animation (e.g., a JSON or Lottie® file) to the client device, where the animation is rendered using an animation engine. Alternatively, the system can render the animation on the server side and distribute a pre-rendered animation file in formats such as WebP, GIF, or MP4. The choice of distribution method can depend on factors such as the client device's capabilities and the desired level of customization. This ensures efficient delivery and optimal playback quality on the client device.

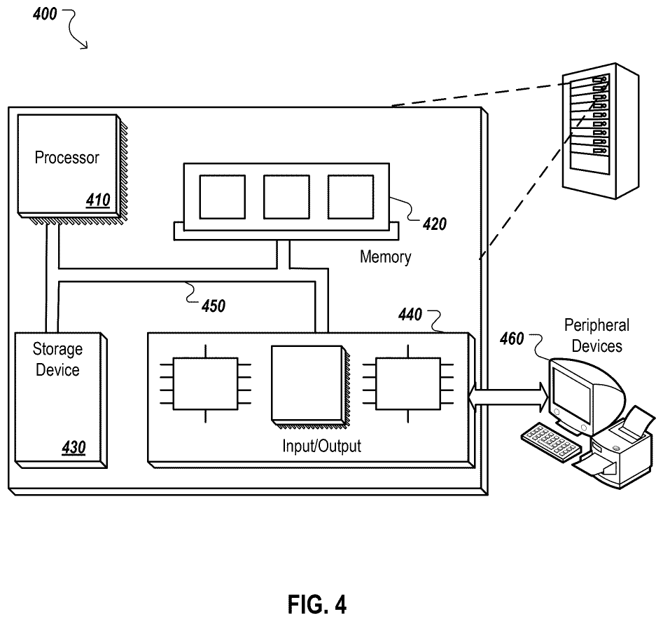

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for generating an animation, the method comprising:
obtaining digital content data comprising one or more digital components;
obtaining an animation template that defines a structure for the animation, the template comprising (i) one or more component slots, each component slot configured to hold at least one of the digital components, and (ii) animation parameters that define animation properties for at least one of the digital components;
processing input data comprising at least the digital content data to determine one or more style features of the animation;
generating animation data defining the animation by applying the determined style features to the one or more digital components and the animation template; and
distributing the animation to one or more client devices.

2. The method of claim 1, wherein the digital components comprise one or more of: an image, text data, a logo, or a graphic shape.

3. The method of claim 2, wherein the style features comprise one or more of: a scale, a position, a font, a font size, an aspect ratio, a display color, a rotation, an opacity, an animation timing of one or more components of the animation.

4. The method of claim 1, wherein processing the input data to determine the one or more style features of the animation comprises:
processing a first input comprising data characterizing at least one of the digital component using a first machine learning model to generate an output comprising at least one of the one or more style features.

5. The method of claim 4, wherein the first input further comprises contextual data characterizing one or more of:
a device type of the client devices, user interface settings, viewing mode, a user profile, digital content presented prior to or concurrently with the animation, or a time of day.

6. The method of claim 1, wherein obtaining the animation template comprises:
processing an input characterizing one or more of: attributes of the one or more digital components, or contextual information, to select the animation template from a set of animation templates.

7. The method of claim 6, further comprising:
receiving a query that comprises characteristics of one or more videos in a video feed, wherein
the contextual information comprises the characteristics of the one or more videos in the video feed.

8. The method of claim 6, wherein processing the input to select the animation template comprises:
processing the input using a second machine learning model to generate an output that identifies the animation template.

9. The method of claim 1, wherein obtaining digital content data comprising one or more digital components comprises:
receiving a query that comprises characteristics of one or more videos in a video feed; and
selecting the one or more digital components based on the characteristics of one or more videos in a video feed.

10. The method of claim 1, wherein distributing the animation to one or more client devices comprises:
generating a rendered animation file; and
distributing the rendered animation file to the client devices.

11. The method of claim 1, wherein distributing the animation to one or more client devices comprises:
distributing a file that defines animation instructions to the client devices and rendering the animation at the client devices using an animation engine.

12. A system comprising:
one or more computers; and
one or more storage devices storing instructions that when executed by the one or more computers, cause the one or more computers to perform operations for generating an animation, the operations comprising:
obtaining digital content data comprising one or more digital components;
obtaining an animation template that defines a structure for the animation, the template comprising (i) one or more component slots, each component slot configured to hold at least one of the digital components, and (ii) animation parameters that define animation properties for at least one of the digital components;
processing input data comprising at least the digital content data to determine one or more style features of the animation;
generating animation data defining the animation by applying the determined style features to the one or more digital components and the animation template; and
distributing the animation to one or more client devices.

13. The system of claim 12, wherein the digital components comprise one or more of: an image, text data, a logo, or a graphic shape.

14. The system of claim 12, wherein the style features comprise one or more of: a scale, a position, a font, a font size, an aspect ratio, a display color, a rotation, an opacity, an animation timing of one or more components of the animation.

15. The system of claim 12, wherein processing the input data to determine the one or more style features of the animation comprises:
processing a first input comprising data characterizing at least one of the digital component using a first machine learning model to generate an output comprising at least one of the one or more style features.

16. The system of claim 15, wherein the first input further comprises contextual data characterizing one or more of:
a device type of the client devices, user interface settings, viewing mode, a user profile, digital content presented prior to or concurrently with the animation, or a time of day.

17. The system of claim 12, wherein obtaining the animation template comprises:
processing an input characterizing one or more of: attributes of the one or more digital components, or contextual information, to select the animation template from a set of animation templates.

18. One or more non-transitory computer-readable storage media storing instructions that, when executed by one or more computers, cause the one or more computers to perform operations for generating an animation, the operations comprising:
obtaining digital content data comprising one or more digital components;
obtaining an animation template that defines a structure for the animation, the template comprising (i) one or more component slots, each component slot configured to hold at least one of the digital components, and (ii) animation parameters that define animation properties for at least one of the digital components;
processing input data comprising at least the digital content data to determine one or more style features of the animation;
generating animation data defining the animation by applying the determined style features to the one or more digital components and the animation template; and
distributing the animation to one or more client devices.

19. The one or more non-transitory computer-readable storage media of claim 18, wherein the digital components comprise one or more of: an image, text data, a logo, or a graphic shape.

20. The one or more non-transitory computer-readable storage media of claim 18, wherein the style features comprise one or more of: a scale, a position, a font, a font size, an aspect ratio, a display color, a rotation, an opacity, an animation timing of one or more components of the animation.
